(19) United States
(12) Patent Application Publication
(10) Pub. No.: US 2024/0246156 A1
(43) Pub. Date: Jul. 25, 2024

(54) BIT HOLDER

(71) Applicant: MILWAUKEE ELECTRIC TOOL CORPORATION, Brookfield, WI (US)

(72) Inventors: Evan H. Fischer, Milwaukee, WI (US); Matthew J. Fiddes, Milwaukee, WI (US); Katherine J. Haim, Hartland, WI (US); James J. Van Essen, Hales Corners, WI (US)

(21) Appl. No.: 18/415,867

(22) Filed: Jan. 18, 2024

Related U.S. Application Data
(60) Provisional application No. 63/480,758, filed on Jan. 20, 2023.

(51) Int. Cl. B23B 31/107; B25B 23/00

(52) U.S. Cl. CPC B23B 31/1071; B25B 23/0035

(57) ABSTRACT

A bit holder configured to be driven by a power tool. The bit holder includes a shank, a bit holding body, a bearing, and a sleeve. The shank defines a groove. The bit holding body defines a longitudinal bore that receives a portion of the shank and an aperture defined in a surface of the bit holding body that is in fluid communication with the longitudinal bore. The bearing is received at least partially in the aperture of the bit holding body and at least partially in the groove of the shank. The sleeve including a step. The sleeve disposed over the shank and the bit holding body such that the step is radially aligned with the groove of the shank, the aperture of the bit holding body, and the bearing to inhibit the bearing from moving out of the groove and the aperture.

### CROSS-REFERENCE TO RELATED APPLICATION

This application claims priority to U.S. Provisional Patent Application No. 63/480,758, filed on Jan. 20, 2023, the entire contents of which are incorporated herein by reference.

### FIELD OF THE INVENTION

The present invention relates to power tool accessories. More specifically, the present invention relates to bit holders.

### SUMMARY

In one aspect, the disclosure provides a bit holder configured to be driven by a power tool. The bit holder includes a shank, a bit holding body, a bearing, and a sleeve. The shank is configured to be coupled to the power tool. The shank defines a groove. The bit holding body defines a longitudinal bore that receives a portion of the shank and an aperture defined in a surface of the bit holding body that is in fluid communication with the longitudinal bore. The bearing is received at least partially in the aperture of the bit holding body and at least partially in the groove of the shank. The sleeve including a step. The sleeve disposed over the shank and the bit holding body such that the step is radially aligned with the groove of the shank, the aperture of the bit holding body, and the bearing to inhibit the bearing from moving out of the groove and the aperture.

In another aspect, the disclosure provides a bit holder configured to be driven by a power tool. The bit holder includes a shank, a bit holding body, a bearing, and a sleeve. The shank is configured to be coupled to and receive torque from the power tool. The bit holding body defines a longitudinal bore that receives a portion of the shank. The bearing selectively couples the shank and the bit holding body together. The sleeve is disposed over the shank and the bit holding body. The sleeve is movable relative to the shank and the bit holding body to shift the bit holder between a first state, in which the shank is configured to transfer torque from the power tool to the bit holding body via the bearing, and a second state in which the shank rotates independently of the bit holding body.

In another aspect, the disclosure provides a bit holder configured to be driven by a power tool. The bit holder includes a shank, a bit holding body, a bearing, and a sleeve. The shank is configured to be coupled to and receive torque from the power tool. The bit holding body defines a longitudinal bore that receives a portion of the shank. The bearing is movable between a first position in which the bearing radially overlaps at least a portion of the shank and at least a portion of the bit holding body such that the shank is configured to transfer torque to the bit holding body from the power tool via the bearing and a second position in which the bearing radially overlaps at least a portion of just one of the shank and the bit holding body such that the shank and the bit holding body are configured to rotate independently of one another. The sleeve is disposed over the shank and the bit holding body. The sleeve is configured to selectively hold the bearing in the first position.

Other aspects of the invention will become apparent by consideration of the detailed description and accompanying drawings.

### BRIEF DESCRIPTION OF THE DRAWINGS

FIG. 1 is perspective view of a bit holder in a normal state, the bit holder including a shank, a bit holding body, and a sleeve according to an embodiment of the disclosure.

FIG. 2 is a perspective view of the shank of FIG. 1.

FIG. 3 is an exploded view of the bit holder of FIG. 1.

FIG. 4A is a cross-sectional view of the bit holder of FIG. 1 in the normal state.

FIG. 4B is another cross-sectional view of the bit holder of FIG. 1 in the normal state.

FIG. 5 is a cross-sectional view of the bit holder of FIG. 1 in a torque overload state.

FIG. 6 is a perspective view of a bit holder in a normal state, the bit holder including a shank, a bit holding body, a first sleeve, and a second sleeve according to another embodiment of the disclosure.

FIG. 7 is an exploded view of the bit holder of FIG. 6.

FIG. 8 is a cross-sectional view of the bit holder of FIG. 6 in the normal state.

FIG. 9 is a cross-sectional view of the bit holder of FIG. 6 in a torque overload state.

FIG. 10 is a perspective view of a bit holder in a normal state, the bit holder including a shank, a bit holding body, a first sleeve, and a second sleeve according to another embodiment of the disclosure.

FIG. 11 is an exploded view of the bit holder of FIG. 10.

FIG. 12A is a cross-sectional view of the bit holder of FIG. 10 in the normal state taken along the center of the bit holder.

FIG. 12B is a cross-sectional view of the bit holder of FIG. 10 in the normal state taken along the center of the bit holder and rotated 90 degrees about a central longitudinal axis of the bit holder from the view of FIG. 12A.

FIG. 12C is a cross-sectional view of the bit holder of FIG. 10 in the normal state taken along line C-C.

FIG. 13A is a cross-sectional view of the bit holder of FIG. 10 in a torque overload state and taken along the center of the bit holder.

FIG. 13B is a cross-sectional view of the bit holder of FIG. 10 taken along line C-C when the bit holder is in the torque overload state.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

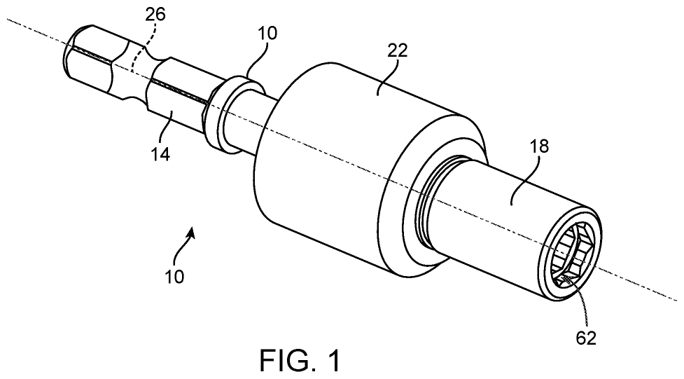

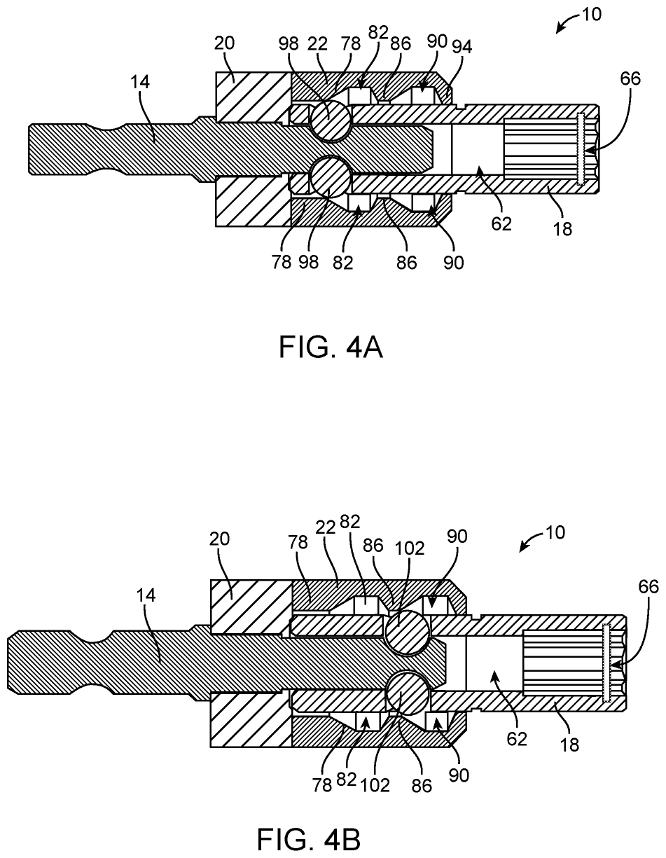

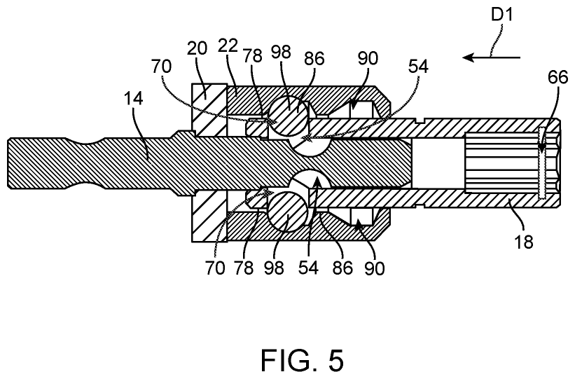

FIG. 1 illustrates a bit holder 10. The bit holder 10 includes a shank 14, a bit holding body 18, a flexible sleeve 20 (FIGS. 4A-5), and a rigid sleeve 22. The bit holder 10 defines an axis 26 that extends longitudinally through the center of the bit holder 10 such that the bit holder 10 is configured to rotate about the axis 26. The shank 14 is configured to be coupled to a power tool for rotation of the bit holder 10. The bit holding body 18 is configured to retain a tool bit such that the power tool drives rotation of the bit holder 10 and the tool bit. The tool bit may be, for example, a drill bit, a driver bit, and the like. Each of the flexible sleeve 20 and the rigid sleeve 22 is disposed around the shank 14 and the bit holding body 18 to absorb shock from operation of the bit holder 10. As such, as the power tool transfers torque to the shank 14 of the bit holder 10, the shank 14 may then transfer torque to either the rigid sleeve 22, the bit holding body 18, or both, as will be described in further detail below.

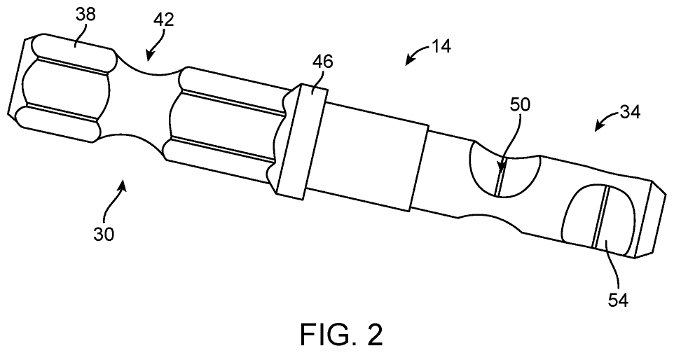

As illustrated in FIG. 2, the shank 14 includes a tool coupling portion 30 and a bit holding coupling portion 34. The tool coupling portion 30 includes a body 38 and a groove 42. In the illustrated embodiment, the body 38 has a hexagonal cross-section. At least a portion of the body 38 is engageable with the power tool to rotationally couple the shank 14 to the power tool, and the groove 42 may receive a retention member from the power tool (e.g., a detent ball, a clip, etc.) to maintain engagement between the shank 14 and the power tool. In some embodiments, the body 38 of the tool coupling portion 30 may have a different shape. For example, in some embodiments, the tool coupling portion 30 may be configured as an SDS-style shank, such as an SDS shank, an SDS Plus shank, or an SDS Max shank.

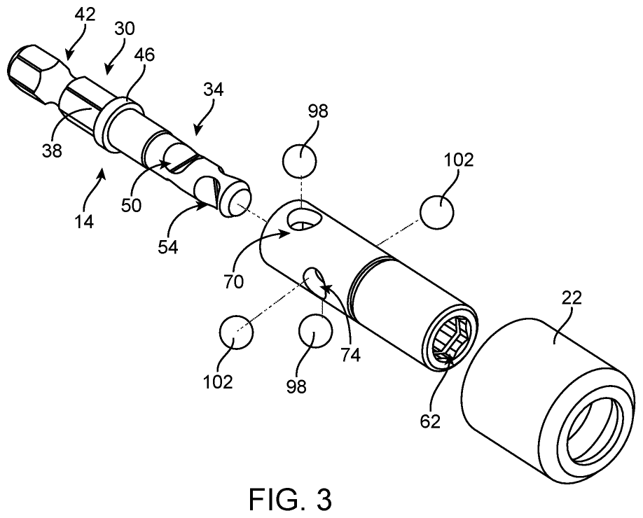

With reference to FIGS. 2 and 3, the bit holding coupling portion 34 is configured to be inserted into the bit holding body 18 to couple the shank 14 to the bit holding body 18. The bit holding coupling portion 34 includes a flange 46 provided adjacent to the tool coupling portion 30 and defines a first groove 50 and a second groove 54. As such, the flange 46 may separate the tool coupling portion 30 and the bit holding coupling portion 34. In the illustrated embodiment, the bit holding coupling portion 34 includes a plurality of first grooves 50 and a plurality of second grooves 54. More specifically, the plurality of first grooves 50 includes two first grooves 50 spaced diametrically apart from each other, and the plurality of second grooves 54 includes two second grooves 54 spaced diametrically apart from each other. Each of the first grooves 50 is spaced circumferentially between the two second grooves 54, and each of the second grooves 54 is spaced circumferentially between the two first grooves 50. The first grooves 50 are positioned axially between the second grooves 54 and the tool coupling portion 30 of the shank 14. In some embodiments, the bit holding coupling portion 34 may only include one first groove 50 and one second groove 54. In other embodiments, the bit holding coupling portion 34 may include more than two first and second grooves 54. In still other embodiments, the bit holding coupling portion may only include one set of grooves (e.g., the first grooves 50 or the second grooves 54).

As illustrated in FIGS. 3-4B, the bit holding body 18 defines a longitudinal bore 62, a tool bit receiving aperture 66, a first aperture 70, and a second aperture 74. The longitudinal bore 62 is in fluid communication with the tool bit receiving aperture 66, the first aperture 70, and the second aperture 74 and is configured to receive the bit holding coupling portion 34. In some embodiments, the longitudinal bore 62 may be isolated from the tool bit receiving aperture 66 by, for example, an internal wall. When the bit holder 10 is assembled, an opening to the tool bit receiving aperture 66 is disposed at an end of the bit holder 10 that is opposite from the shank 14 and is configured to receive a tool bit therein. The illustrated bit receiving aperture 66 has a hexagonal cross-section, but may alternatively have other configurations to receive other types of tool bits. The first aperture 70 includes two openings such that each opening is spaced diametrically across from the other of the two openings of the first aperture 70. The second aperture 74 includes two openings such that each opening is spaced diametrically across from the other of the two openings of the second aperture 74. In some embodiments, the first aperture 70 and the second aperture 74 may each only include one opening. In other embodiments, each aperture 70, 74 may include more than two openings. In still other embodiments, the bit holding body 18 may only include one aperture (e.g., the first aperture 70 or the second aperture 74). In a first or normal state of the bit holder 10, each opening of the first aperture 70 radially aligns with one of the plurality of first grooves 50, and each opening of the second aperture 74 radially aligns with one of the plurality of second grooves 54. As such, in the illustrated embodiment, each opening of the first aperture 70 is circumferentially spaced roughly 90 degrees from the two openings of the second aperture 74, and each opening of the second aperture 74 is circumferentially spaced roughly 90 degrees from the two openings of the first aperture 70.

With continued reference to FIGS. 3-4B, each of the flexible sleeve 20 and the rigid sleeve 22 has a cylindrical body. The flexible sleeve 20 may be formed of a rubber or any similar flexible material such as, for example, neoprene, silicone, natural rubber, and the like. In some embodiments, the flexible sleeve 20 may be, or include, a spring. The flexible sleeve 20 is located between the flange 46 and the rigid sleeve 22 such that the flexible sleeve 20 may bias the rigid sleeve 22 toward the front of the bit holder 10 in the normal state. The rigid sleeve 22 may be formed of a plastic, a metal, or another similar rigid material. The rigid sleeve 22 is disposed around the shank 14 and the bit holding body 18 at a location of the bit holder 10 where the shank 14 is inserted into the longitudinal bore 62 of the bit holding body 18. The rigid sleeve 22 includes a first step 78, a first sleeve groove 82, a second step 86, and a second sleeve groove 90. In some embodiments, the rigid sleeve 22 may only include one step (e.g., the first step 78 or the second step 86) and one groove (e.g., the first sleeve groove 82 or the second sleeve groove 90). In other embodiments, the rigid sleeve 22 may include more than two steps and more than two grooves. Each of the first step 78 and the second step 86 extends from an inner circumferential surface of the rigid sleeve 22. Each of the first sleeve groove 82 and the second sleeve groove 90 is defined in the inner circumferential surface of the rigid sleeve 22. Specifically, the first sleeve groove 82 is defined in the inner circumferential surface of the rigid sleeve 22 between the first step 78 and the second step 86. The second sleeve groove 90 is defined in the inner circumferential surface of the rigid sleeve 22 between the second step 86 and a front end 94 of the rigid sleeve 22.

The first aperture 70 is configured to receive a first bearing 98, and the second aperture 74 is configured to receive a second bearing 102. In the illustrated embodiment, the first aperture 70 is configured to receive two first bearings 98, and the second aperture 74 is configured to receive two second bearings 102. More specifically, the first aperture 70 receives a first bearing 98 in each of the openings of the first aperture 70, and the second aperture 74 receives a second bearing 102 in each of the openings of the second aperture 74. In other embodiments, the bit holder 10 may include fewer or more bearings, depending on the number of apertures and openings. In the normal state, each of the first bearings 98 is disposed in one of the openings of the first aperture 70 and one of the plurality of first grooves 50, and each of the second bearings 102 is disposed in one of the openings of the second aperture 74 and one of the plurality of second grooves 54. Further, the rigid sleeve 22 is disposed at a location on the bit holding body 18 such that the first step 78 radially aligns with the first bearings 98, the first aperture 70, and the plurality of first grooves 50 to inhibit the first bearings 98 from moving out of the first aperture 70 and the plurality of first grooves 50. The second step 86 radially aligns with the second bearings 102, the second aperture 74, and the plurality of second grooves 54 to inhibit the second bearings 102 from moving out of the second aperture 74 and the plurality of second grooves 54. As such, in the normal state, the first bearings 98 and the second bearings 102 are positioned such that the shank 14 is inhibited from rotating relative to the bit holding body 18. In other words, the bearings 98, 102 selectively couple the shank 14 and the bit holding body 18 together.

With reference to FIGS. 4A and 4B, during operation of the bit holder 10 with the bit holder 10 in the normal state, a user may insert the shank 14 into a power tool and may insert a tool bit into the tool bit receiving aperture 66 of the bit holding body 18. The user may then actuate the power tool to drive rotation of the shank 14. As the shank 14 rotates, the shank 14 transfers torque to the first bearings 98 and the second bearings 102, which in turn, transfer torque to the bit holding body 18 to drive rotation of the tool bit for performing a working operation. As the tool bit is driven, the bit holder 10 may reach a torque threshold such that the bit holder 10 is overloaded. After the bit holder reaches the torque threshold, the bit holder 10 shifts from the normal state to a second or torque overload state.

In the torque overload state, as illustrated in FIG. 5, the shank 14 transfers an amount of torque to the first bearings 98 and the second bearings 102 that forces the first bearings 98 out of the first aperture 70 and the plurality of first grooves 50 and that forces the second bearings 102 out of the second aperture 74 and the plurality of second grooves 54. The amount of torque may be any amount of torque at or above the torque threshold. The first bearings 98 and the second bearings 102 then move against the rigid sleeve 22, thereby causing a reactionary movement of the rigid sleeve 22 toward the shank 14 in a direction D1 against the bias of the flexible sleeve 20. As such, the flexible sleeve 20 may be compressed between the rigid sleeve 22 and the flange 46 in the torque overload state. In other words, the flexible sleeve 20 is selectively compressible to allow for axial movement of the rigid sleeve 22 relative to the shank 14 and the bit holding body 18. When the rigid sleeve 22 moves rearwardly toward the shank 14, the first bearings 98 may move into the first sleeve groove 82, and the second bearings 102 may move into the second sleeve groove 90 such that the flexible sleeve 20 and the rigid sleeve 22 at least partially absorb the torque overload.

With the first bearings 98 positioned in the first sleeve groove 82 and the second bearings 102 positioned in the second sleeve groove 90, the first bearings 98 and the second bearings 102 no longer provide an interference between the shank 14 and the bit holding body 18. That is, the first bearings 98 and the second bearings 102 move a distance out of the plurality of first grooves 50 and the plurality of second grooves 54, respectively, such that the first bearings 98 and the second bearings 102 no longer inhibit rotation of the shank 14 relative to the bit holding body 18. Stated another way, the movement of the first bearings 98 and the second bearings 102 may effectively decouple the shank 14 from the bit holding body 18. As such, the power tool may drive rotation of the shank 14 independently of the bit holding body 18 when the first bearings 98 and the second bearings 102 move out of the first grooves 50 and the second grooves 54, respectively. That is, the power tool drives rotation of the shank 14, but the shank 14 does not transfer torque to the bit holding body 18 in the torque overload state. After the bit holder 10 shifts to the torque overload state, a user may release actuation of the power tool to stop rotation of the shank 14. In absence of torque provided by the power tool, the flexible sleeve 20 may automatically bias the rigid sleeve 22 forwardly away from the shank 14 to shift the bit holder 10 back into the normal state.

In some instances, as the bit holder 10 shifts to the torque overload state, the bit holding body 18 may move rearwardly towards the shank 14 in the direction D1. By moving rearwardly towards the shank 14, the bit holding body 18 may reduce wear and impact for the bit holder 10 against a work surface during operation of the bit holder 10. That is, once the bit holder 10 reaches the torque overload state, the bit holding body 18 may slide away from a work surface to inhibit the bit holding body 18 from impacting the work surface after the bit holder 10 has shifted to the torque overload state.

In the illustrated embodiment, the first bearings 98 are movable between a first position (FIG. 4A) and a second position (FIG. 5), and the second bearings 102 are movable between a third position (FIG. 4B) and fourth position. In the first position, the first bearings 98 radially overlap at least a portion of the shank 14 and at least a portion of the bit holding body 18 such that the shank 14 is configured to transfer torque to the bit holding body 18 from the power tool via the first bearings 98. In the second position, the first bearings 98 radially overlap at least a portion of just one of the shank 14 and the bit holding body 18 such that the shank 14 and the bit holding body 18 are configured to rotate independently of one another.

In the third position, the second bearings 102 radially overlap at least a portion of the shank 14 and at least a portion of the bit holding body 18 such that the shank 14 is configured to transfer torque to the bit holding body 18 from the power tool via the second bearings 102. In the fourth position, the second bearings 102 radially overlap at least a portion of just one of the shank 14 and the bit holding body 18 such that the shank 14 and the bit holding body 18 are configured to rotate independently of one another. As such, the first position and the third position are axially spaced from one another and are otherwise substantially similar. The second position and the fourth position are axially spaced from one another and are otherwise substantially similar.

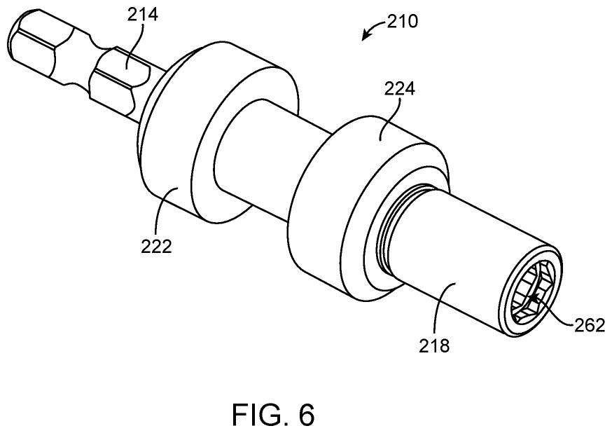

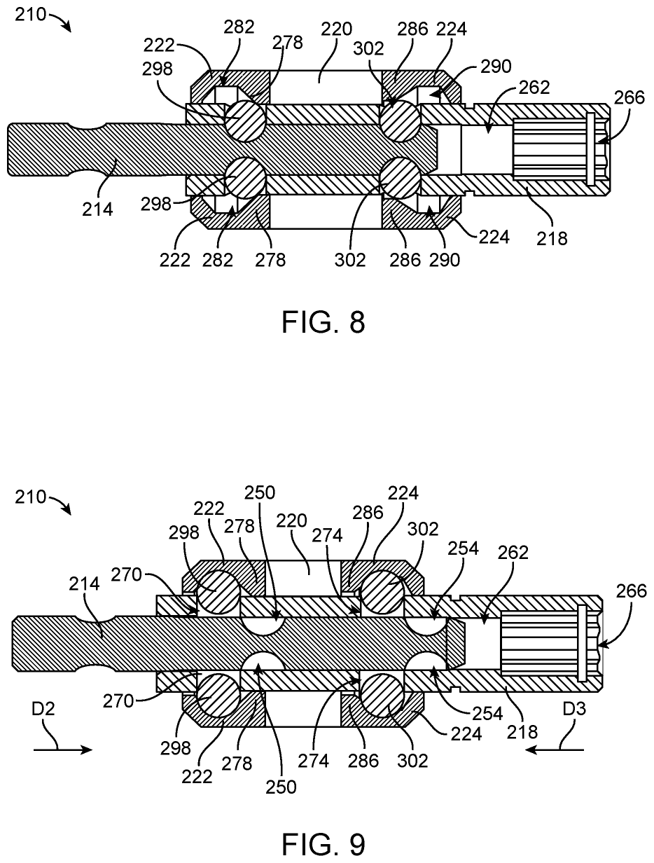

FIG. 6 illustrates another embodiment of a bit holder 210. The bit holder 210 may be substantially similar to the bit holder 10 of FIG. 1 except for the differences described below. As illustrated in FIG. 6, the bit holder 210 includes a shank 214, a bit holding body 218, a flexible sleeve 220, a first rigid sleeve 222 (FIGS. 8 and 9), and a second rigid sleeve 224.

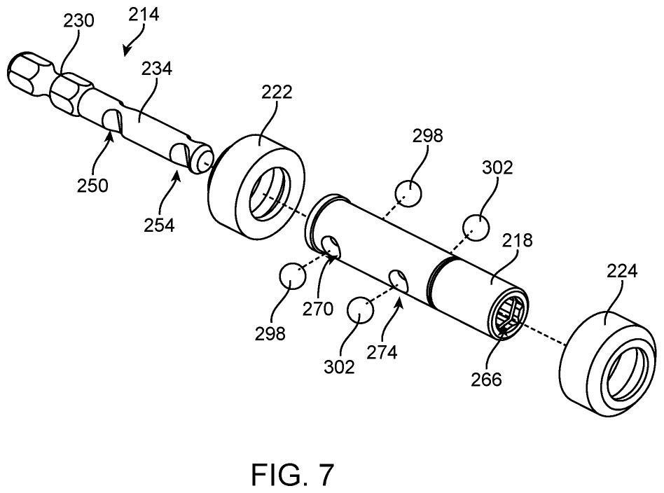

With reference to FIG. 7, the shank 214 includes a tool coupling portion 230 and a bit holding coupling portion 234. The tool coupling portion 230 is engageable with a power tool to couple the bit holder 210 to the power tool. The bit holding coupling portion 234 is configured to be inserted into the bit holding body 218 to couple the shank 214 to the bit holding body 218. The bit holding coupling portion 234 defines a first groove 250 and a second groove 254. In the illustrated embodiment, the bit holding coupling portion 234 defines a plurality of first grooves 250 and a plurality of second grooves 254. Specifically, the plurality of first grooves 250 includes two first grooves 250, and the plurality of second grooves 254 includes two second grooves 254. In other embodiments, the bit holding coupling portion 234 may include fewer or more grooves. Each of the first grooves 250 is spaced diametrically from the other of the first grooves 250, and each of the second grooves 254 is spaced diametrically from the other of the second grooves 254. Each of the first grooves 250 is provided in circumferential alignment with one of the second grooves 254. That is, the first grooves 250 are not positioned circumferentially between the second grooves 254, and the second grooves 254 are not positioned circumferentially between the first grooves 250. The plurality of first grooves 250 is positioned axially between the shank 214 and the plurality of second grooves 254.

With continued reference to FIG. 7, the bit holding body 218 defines a longitudinal bore 262, a tool bit receiving aperture 266, a first aperture 270, and a second aperture 274. The longitudinal bore 262 is in fluid communication with the tool bit receiving aperture 266, the first aperture 270, and the second aperture 274 and is configured to receive the bit holding coupling portion 234. When the bit holder 210 is assembled, the first aperture 270 aligns radially with the plurality of first grooves 250, and the second aperture 274 aligns radially with the plurality of second grooves 254. The first aperture 270 includes two openings such that each opening is spaced diametrically across from the other of the two openings of the first aperture 270, and the second aperture 274 includes two openings such that each opening is spaced diametrically across from the other of the two openings of the second aperture 274. In the illustrated embodiment, each opening of the first aperture 270 is circumferentially aligned with one of the openings of the second aperture 274, and each opening of the second aperture 274 is circumferentially aligned with one of the openings of the first aperture 270. In other embodiments, the bit holding body 218 may include fewer or more apertures and openings. When the bit holder 210 is assembled, the first aperture 270 is positioned axially between the shank 214 and the second aperture 274.

Each of the flexible sleeve 220, the first rigid sleeve 222, and the second rigid sleeve 224 has a cylindrical body. The flexible sleeve 220 may be formed of a rubber or any similar flexible material, such as, for example, neoprene, silicone, natural rubber, and the like. In some embodiments, the flexible sleeve 220 may be, or include, a spring. The flexible sleeve 220 is located between the first rigid sleeve 222 and the second rigid sleeve 224 such that the flexible sleeve 220 may bias the first rigid sleeve 222 toward the shank 214 and may bias the second rigid sleeve 224 toward the front of the bit holder 10. Each of the first rigid sleeve 222 and the second rigid sleeve 224 may be formed of a plastic, a metal, or another similar material. In some embodiments the first rigid sleeve 222 and the second rigid sleeve 224 may be formed of the same material. In other embodiments, the first rigid sleeve 222 and the second rigid sleeve 224 may be formed of different materials. As illustrated in FIGS. 7 and 8, the first rigid sleeve 222 is disposed around the shank 214 and the bit holding body 218 at the location of the first grooves 250 and the first aperture 270. The second rigid sleeve 224 is disposed around the shank 214 and the bit holding body 218 at the location of the second grooves 254 and the second aperture 274. The first rigid sleeve 222 includes a first step 278 and a first sleeve groove 282. The second rigid sleeve 224 includes a second step 286 and a second sleeve groove 290.

The first aperture 270 is configured to receive a first bearing 298, and the second aperture 274 is configured to receive a second bearing 302. In the illustrated embodiment, the first aperture 270 is configured to receive two first bearings 298, and the second aperture 274 is configured to receive two second bearings 302. More specifically, the first aperture 270 receives a first bearing 298 in each of the openings of the first aperture 270, and the second aperture 274 receives a second bearing 302 in each of the openings of the second aperture 274. In other embodiments, the bit holder 210 may include fewer or more bearings. In a first or normal state, the first step 278, the first aperture 270, the plurality of first grooves 250, and the first bearings 298 are radially aligned such that the first step 278 inhibits the first bearings 298 from moving out of the first aperture 270 and the plurality of first grooves 250. Further in the normal state, the second step 286, the second aperture 274, the plurality of second grooves 254, and the second bearings 302 are radially aligned such that the second step 286 inhibits the second bearings 302 from moving out of the second aperture 274 and the plurality of second grooves 254.

With reference to FIG. 9, the bit holder 210 may be operated substantially similarly to the bit holder 10 of FIGS. 1-5. As such, when the power tool transfers an amount of torque to the bit holder 210 that is above a torque threshold, the bit holder 210 may shift from the normal state to a second or torque overload state. In the torque overload state, the first bearings 298 move against the first rigid sleeve 222, thereby causing a reactionary movement of the first rigid sleeve 222 in a first direction D2 against the bias of the flexible sleeve 220. Further in the torque overload state, the second bearings 302 move against the second rigid sleeve 224, thereby causing a reactionary movement of the second rigid sleeve 224 in a second direction D3 that is opposite the first direction D2. In the illustrated embodiment, the first direction D2 is oriented in the direction from the shank 214 to the bit holding body 218, and the second direction D3 is oriented in the direction from the bit holding body 218 to the shank 214. As such, the flexible sleeve 220 may be compressed between the first rigid sleeve 222 and the second rigid sleeve 224 in the torque overload state. When the first rigid sleeve 222 moves in the first direction D2, the first bearings 298 may move into the first sleeve groove 282, and the second bearings 302 may move into the second sleeve groove 290 such that the flexible sleeve 220, the first rigid sleeve 222 and the second rigid sleeve 224 at least partially absorb the torque overload. In some instances, the bit holding body 218 may move in the second direction D3 as the bit holder 210 shifts from the normal state to the torque overload state.

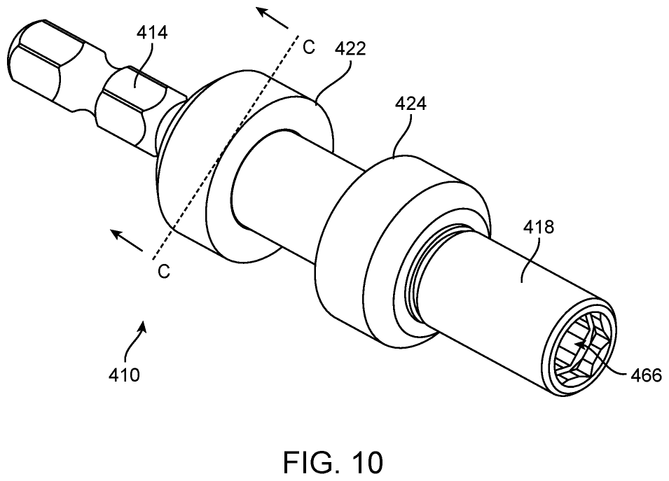

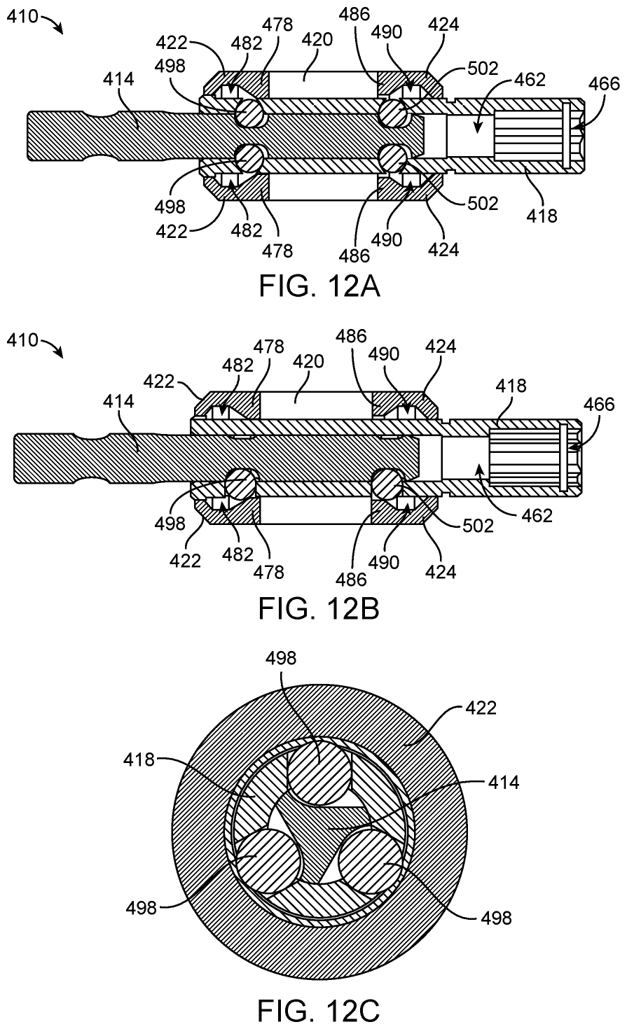

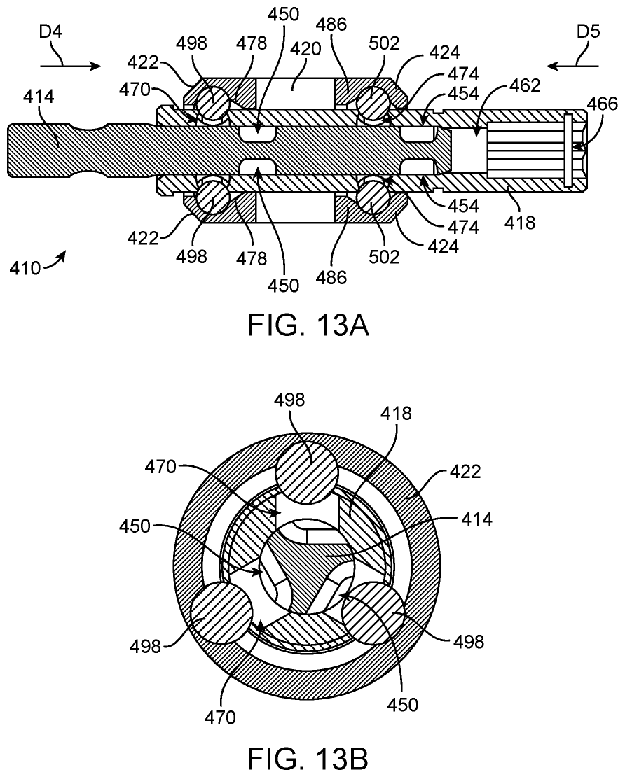

FIG. 10 illustrates a bit holder 410 according to another embodiment of the disclosure. The bit holder 410 is substantially similar to the bit holder 10 of FIGS. 1-5 and the bit holder 210 of FIGS. 6-10 except for the differences described below. As illustrated in FIG. 10, the bit holder 410 includes a shank 414, a bit holding body 418, a flexible sleeve 420 (FIGS. 12A and 13A), a first rigid sleeve 422, and a second rigid sleeve 424.

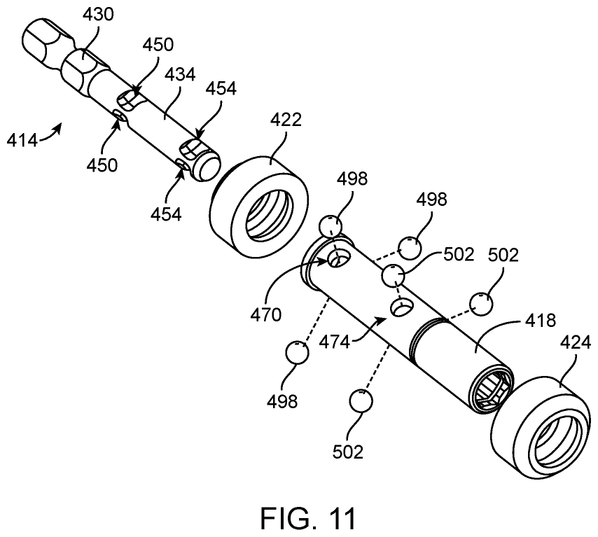

As illustrated in FIGS. 11-12C, the shank 414 includes a tool coupling portion 430 and a bit holding coupling portion 434. The tool coupling portion 430 is engageable with a power tool to couple the bit holder 410 to the power tool. The bit holding coupling portion 434 is configured to be inserted into the bit holding body 418 to couple the shank 414 to the bit holding body 418. The bit holding coupling portion 434 defines a first groove 450 and a second groove 454. In the illustrated embodiment, the bit holding coupling portion 434 defines a plurality of first grooves 450 and a plurality of second grooves 454. Specifically, the plurality of first grooves 450 includes three first grooves 450, and the plurality of second grooves 454 includes three second grooves 454. In other embodiments, the bit holding coupling portion 434 may include fewer or more grooves. Each of the three first grooves 450 is spaced circumferentially equidistant from the two other of the three first grooves 450. Each of the three second grooves 454 is spaced circumferentially equidistant from the two other of the three second grooves 454. Each of the first grooves 450 is provided in circumferential alignment with a corresponding one of the second grooves 454, and each of the second grooves 454 is provided in circumferential alignment with one of the first grooves 450. The plurality of first grooves 450 is positioned axially between the shank 414 and the plurality of second grooves 454.

With continued reference to FIGS. 11-12C, the bit holding body 418 defines a longitudinal bore 462, a tool bit receiving aperture 466, a first aperture 470, and a second aperture 474. The longitudinal bore 462 is in fluid communication with the tool bit receiving aperture 466 and is configured to receive the bit holding coupling portion 434. When the bit holder 410 is assembled, the first aperture 470 aligns radially with the plurality of first grooves 450, and the second aperture 474 aligns radially with the plurality of second grooves 454. The first aperture 470 includes three openings such that each opening is spaced circumferentially equidistant from the other two openings of the three openings of the first aperture 470. The second aperture 474 includes three openings such that each opening is spaced circumferentially equidistant from the other two openings of the three openings of the second aperture 474. In the illustrated embodiment, each opening of the first aperture 470 is circumferentially aligned with a corresponding one of the openings of the second aperture 474, and each opening of the second aperture 474 is circumferentially aligned with a corresponding one of the openings of the first aperture 470. In other embodiments, the bit holding body 418 may include fewer or more apertures and openings. When the bit holder 410 is assembled, the first aperture 470 is positioned axially between the shank 414 and the second aperture 474.

Each of the flexible sleeve 420, the first rigid sleeve 422 and the second rigid sleeve 424 has a cylindrical body. The flexible sleeve 420 may be formed of a rubber or any similar flexible material, such as, for example, neoprene, silicone, natural rubber, and the like. In some embodiments, the flexible sleeve 420 may be, or include, a spring. The flexible sleeve 220 is located between the first rigid sleeve 422 and the second rigid sleeve 424 such that the flexible sleeve 420 may bias the first rigid sleeve 422 toward the shank 414 and may bias the second rigid sleeve 424 toward the front of the bit holder 10. Each of the first rigid sleeve 422 and the second rigid sleeve 424 may be formed of a plastic, a metal, or another similar material. In some embodiments, the first rigid sleeve 422 and the second rigid sleeve 424 may be formed of the same material. In other embodiments, the first rigid sleeve 422 and the second rigid sleeve 424 may be formed of different materials. As illustrated in FIGS. 11-12C, the first rigid sleeve 422 is disposed around the shank 414 and the bit holding body 418 at the location of the first grooves 450 and the first aperture 470. The second rigid sleeve 424 is disposed around the shank 414 and the bit holding body 418 at the location of the second grooves 454 and the second aperture 474. The first rigid sleeve 422 includes a first step 478 and a first sleeve groove 482. The second rigid sleeve 424 includes a second step 486 and a second sleeve groove 490.

The first aperture 470 is configured to receive a first bearing 498, and the second aperture 474 is configured to receive a second bearing 502. In the illustrated embodiment, the first aperture 470 is configured to receive three first bearings 498, and the second aperture 474 is configured to receive three second bearings 502. More specifically, the first aperture 470 receives a first bearing 498 in each of the openings of the first aperture 470, and the second aperture 474 receives a second bearing 502 in each of the openings of the second aperture 474. In other embodiments, the bit holder 410 may include fewer or more bearings. In the first or normal state, the first step 478 radially overlaps each opening of the first aperture 470, each of the plurality of first grooves 450, and each of the first bearings 498 such that the first step 478 inhibits the first bearings 498 from moving out of the first aperture 470 and the plurality of first grooves 450. Further in the normal state, the second step 486 radially overlaps each opening of the second aperture 474, each of the plurality of second grooves 454, and each of the second bearings 502 such that the second step 486 inhibits the second bearings 502 from moving out of the second aperture 474 and the plurality of second grooves 454.

With reference to FIGS. 13A and 13B, the bit holder 410 may be operated substantially similarly to the bit holder 10 of FIGS. 1-5 and the bit holder 210 of FIGS. 6-10. As such, when the power tool transfers an amount of torque to the bit holder 410 that is above a torque threshold, the bit holder 410 may shift from the normal state to a second or torque overload state. In the torque overload state, the first bearings 498 move against the first rigid sleeve 422, thereby causing a reactionary movement of the first rigid sleeve 422 in a first direction D4 against the bias of the flexible sleeve 420. Further in the torque overload state, the second bearings 502 move against the second rigid sleeve 424, thereby causing a reactionary movement of the second rigid sleeve 424 in a second direction D5 that is opposite the first direction D4. In the illustrated embodiment, the first direction D4 is oriented in the direction from the shank 414 to the bit holding body 418, and the second direction D5 is oriented in the direction from the bit holding body 418 to the shank 414. As such, the flexible sleeve 420 may be compressed between the first rigid sleeve 422 and the second rigid sleeve 424 in the torque overload state. When the first rigid sleeve 422 moves in the first direction D4, the first bearings 498 may move into the first sleeve groove 482, and the second bearings 502 may move into the second sleeve groove 490 such that the flexible sleeve 420, the first rigid sleeve 422, and the second rigid sleeve 424 at least partially absorb the torque overload. In some instances, the bit holding body 418 may move in the second direction D5 as the bit holder 410 shifts from the normal state to the torque overload state.

As described above, some or all illustrated features may be omitted in a particular implementation within the scope of the present disclosure, and some illustrated features may not be required for implementation of all embodiments. The features described above may be implemented in an order different from the order described above and does not prohibit implementation in another order or combination. While not explained in detail for each embodiment and/or construction, the features of the disclosure described herein may be included on a bit holder independent of other features and are not limited to the illustrated disclosure. Embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A bit holder configured to be driven by a power tool, the bit holder comprising:
a shank configured to be coupled to the power tool, the shank defining a groove;
a bit holding body defining a longitudinal bore that receives a portion of the shank and an aperture defined in a surface of the bit holding body that is in fluid communication with the longitudinal bore;
a bearing received at least partially in the aperture of the bit holding body and at least partially in the groove of the shank; and
a sleeve including a step, the sleeve disposed over the shank and the bit holding body such that the step is radially aligned with the groove of the shank, the aperture of the bit holding body, and the bearing to inhibit the bearing from moving out of the groove and the aperture.

2. The bit holder of claim 1, wherein the groove is a first groove, the aperture is a first aperture, the bearing is a first bearing, and the step is a first step, wherein the shank defines a second groove, the bit holding body defines a second aperture, the bit holder includes a second bearing, and the sleeve includes a second step; and
wherein the second step is radially aligned with the second groove of the shank, the second aperture of the bit holding body, and the second bearing to inhibit the second bearing from moving out of the second groove and the second aperture.

3. The bit holder of claim 2, wherein the first groove is one of two first grooves spaced diametrically apart from each other, and wherein the second groove is one of two second grooves spaced diametrically apart from each other, each of the second grooves axially spaced from the first grooves.

4. The bit holder of claim 3, wherein each of the second grooves is circumferentially offset between the two first grooves.

5. The bit holder of claim 3, wherein each of the second grooves is circumferential aligned with a corresponding one of the first grooves.

6. The bit holder of claim 3, wherein the first aperture is one of two first apertures, wherein the second aperture is one of two second apertures, wherein each of the first apertures is radially aligned with a corresponding one of the first grooves, and wherein each of the second apertures is radially aligned with a corresponding one of the second grooves.

7. The bit holder of claim 1, wherein the sleeve is a first sleeve, the bit holder further including a second sleeve positioned between a tool coupling portion of the shank and the first sleeve, and wherein the second sleeve is compressible to allow for axial movement of the first sleeve relative to the shank and the bit holding body.

8. The bit holder of claim 7, wherein axial movement of the first sleeve relative to the shank and the bit holding body moves the step out of radial alignment with the groove of the shank, the aperture of the bit holding body, and the bearing such that the bearing can move out of the groove of the shank.

9. The bit holder of claim 7, wherein the shank includes a flange that separates the tool coupling portion from the portion of the shank that is received in the bit holding body, and wherein the second sleeve is selectively compressible against the flange as the first sleeve moves axially relative to the bit holding body.

10. The bit holder of claim 7, wherein the bit holder further includes a third sleeve, wherein the second sleeve is positioned between the first sleeve and the third sleeve, and wherein each of the first sleeve and the third sleeve is movable relative to the shank and the bit holding body in a direction towards the other of the first sleeve and the third sleeve.

11. A bit holder configured to be driven by a power tool, the bit holder comprising:
a shank configured to be coupled to and receive torque from the power tool;
a bit holding body defining a longitudinal bore that receives a portion of the shank;
a bearing that selectively couples the shank and the bit holding body together; and
a sleeve disposed over the shank and the bit holding body, the sleeve movable relative to the shank and the bit holding body to shift the bit holder between a first state, in which the shank is configured to transfer torque from the power tool to the bit holding body via the bearing, and a second state, in which the shank rotates independently of the bit holding body.

12. The bit holder of claim 11, wherein the sleeve is configured to move relative to the shank and the bit holding body to shift the bit holder to the second state when a torque that is transferred between the shank and the bit holding body is at or above a torque threshold.

13. The bit holder of claim 11, wherein the sleeve defines a sleeve groove, and wherein the bearing is configured to move away from the shank and into the sleeve groove to decouple the shank from the bit holding body when a torque is transferred between the shank and the bit holding body that is at or above a torque threshold.

14. The bit holder of claim 11, wherein the shank defines a groove and the bit holding body defines an aperture, and wherein the bearing is at least partially received in the groove and the aperture to couple the shank to the bit holding body when the bit holder is in the first state.

15. The bit holder of claim 14, wherein the sleeve includes a step and defines a sleeve groove, wherein the step is radially aligned with the groove of the shank and the aperture of the bit holding body to hold the bearing at least partially within the groove and the aperture when the bit holder is in the first state, and wherein the sleeve is movable relative to the shank and the bit holding body to shift the bit holder from the first state to the second state such that the sleeve groove is radially aligned with the groove of the shank and the aperture of the bit holding body, thereby allowing the bearing to move out of the groove of the shank and into the sleeve groove when the bit holder is in the second state.

16. The bit holder of claim 11, wherein the sleeve is a first sleeve, wherein the bit holder further includes a second sleeve that abuts the first sleeve and biases the first sleeve toward a front of the bit holder, and wherein the second sleeve is compressible to allow the first sleeve to move axially relative to the shank and the bit holding body to shift the bit holder from the first state to the second state.

17. The bit holder of claim 16, wherein the bit holder further includes a third sleeve, wherein the second sleeve is positioned between the first sleeve and the second sleeve, and wherein each of the first sleeve and the third sleeve is movable relative to the shank and the bit holding body in a direction towards the other of the first sleeve and the third sleeve to shift the bit holder from the first state to the second state.

18. A bit holder configured to be driven by a power tool, the bit holder comprising:
a shank configured to be coupled to and receive torque from the power tool;
a bit holding body defining a longitudinal bore that receives a portion of the shank;
a bearing movable between
a first position in which the bearing radially overlaps at least a portion of the shank and at least a portion of the bit holding body such that the shank is configured to transfer torque to the bit holding body from the power tool via the bearing, and
a second position in which the bearing radially overlaps at least a portion of just one of the shank and the bit holding body such that the shank and the bit holding body are configured to rotate independently of one another; and
a sleeve disposed over the shank and the bit holding body, the sleeve configured to selectively hold the bearing in the first position.

19. The bit holder of claim 18, wherein the bearing is a first bearing, the bit holder further including a second bearing that is axially spaced from the first bearing and movable between
a third position in which the second bearing radially overlaps at least a portion of the shank and at least a portion of the bit holding body such that the shank is configured to transfer torque to the bit holding body from the power tool via the second bearing, and
a fourth position in which the second bearing radially overlaps at least a portion of just one of the shank and the bit holding body such that the shank and the bit holding body are configured to rotate independently of one another.

20. The bit holder of claim 19, wherein the first bearing is configured to move from the first position to the second position and the second bearing is configured to move from the third position to the fourth position in response to a torque transferred between the shank and the bit holding body that is at or above a torque threshold.
